(19) United States
(12) Patent Application Publication
(10) Pub. No.: US 2012/0135746 A1
(43) Pub. Date: May 31, 2012

(54) METHOD AND APPARATUS FOR DETERMINING AND PROVIDING LOCATION-BASED RESOURCE AVAILABILITY INFORMATION BASED ON MOBILE DEVICE DATA

(75) Inventors: Matthias Möhlig, Berlin (DE); Dominic Letz, Berlin (DE)

(73) Assignee: Nokia Corporation, Espoo (FI)

(21) Appl. No.: 12/956,872

(22) Filed: Nov. 30, 2010

(51) Int. Cl. H04W 64/00

(52) U.S. Cl. 455/456.1

(57) ABSTRACT

An approach for determining and providing location-based facility resource availability information, such as parking space availability at a parking facility, independent of any supporting infrastructure installed at the resource facilities, is provided. Flow data of users entering and exiting the at least one location-based resource is received. Availability of space at the at least one location-based resource is determined based at least in part on the flow data. Resource availability data based at least in part on the availability of space at the at least one location-based resource is provided to a user.

### BACKGROUND

Service providers and device manufacturers (e.g., wireless, cellular, etc.) are continually challenged to deliver value and convenience to consumers by, for example, providing compelling network services.

Various navigation systems and methods have been developed for using location sensing (such as GPS) and electronic mapping technologies to provide navigation services, including the provision of traffic condition information, distance information and estimated travel times. Some vehicle navigation systems also provide various navigation-related functions such as location and directions to various types of desired resources, such as restaurants, gas stations, lodging and parking facilities. Additionally, services can be provided, layered over such navigation systems, which provide certain details regarding desired resources. For example, with respect to parking facilities, some such systems provide information regarding available parking in parking facilities within the vicinity of the user's location or destination.

For example, U.S. Pat. No. 6,927,700 (“hereinafter referred to as the '700 Patent”) describes a method and apparatus for communicating data relating to the locations and availability status of parking spaces for automobiles. The system of the '700 Patent employs detector devices that are mounted at various monitored parking spaces. The detectors detect the presence or absence of a vehicle in an associated parking space, and the availability information with respect to the monitored parking spaces is stored in a database. A graphical map incorporating the parking space availability data is made available to the public over the Internet or over other communication networks. The system of the '700 Patent, however, requires the placement of detector devices at the parking facilities to be monitored, and requires networking and communications infrastructure for accessing the monitored data. The infrastructure adds considerable expense in deploying such a parking resource availability service, and limits the service to only those facilities that have been outfitted with the requisite infrastructure.

As another example, U.S. Patent Application Publication No. 2008/0048885 (“hereinafter referred to as the '48885 Application”) describes a method for predicting parking space availability information based on historical data associated with a given parking space. The method of the '48885 Application involves the collection of a historical record of parking space usage data for various specific parking spaces for which the availability information will be predicted. The historical data can be collected using detecting devices such as those described in the '700 Patent. Based on the historical data for a given parking space, a probability is computed regarding the availability for the given parking as a function of time. The computed probability is used to provide a prediction as to the availability of a given parking space at a desired point in time. As with the system of the '700 Patent, the '48885 Application also requires the deployment of detection devices at all parking facilities for which parking availability predictions will be provided, or at a minimum requires some sort of cooperation from such parking facilities to provide the historical data. Additionally, with the '48885 Application, parking space availability predictions can be provided only for parking facilities that have been outfitted with the detector devices and have been networked with the ultimate service provider, or that otherwise cooperate with the service provider.

Accordingly, existing systems and methods for providing parking space availability information, or other facility resource availability information, require an investment of considerable expense and time associated with the infrastructure required at the particular facilities, and limits the services to only those facilities that have been outfitted with the requisite infrastructure.

### Some Example Embodiments

Therefore, there is a need for a system and method for determining and providing location-based facility resource availability information, such as parking space availability at a parking facility, independent of any supporting infrastructure installed at the resource facilities.

According to one embodiment, a method comprises determining to receive flow data of users entering and exiting the at least one location-based resource, determining an availability of space at the at least one location-based resource based at least in part on the flow data, and determining to provide resource availability data based at least in part on the availability of space at the at least one location-based resource to a user. The method further comprises mapping the at least one location-based resource on a navigation map. The method also comprises generating a heat map based at least in part on the flow data of users entering and exiting the at least one location-based resource, wherein the heat map comprises a weighting of the flow data, determining to receive updated flow data of users entering and exiting the at least one location-based resource at predetermined intervals of time, and updating the heat map based at least in part on the updated flow data, wherein the determination of the availability of space at the at least one location-based resource is further based at least in part on a current weighting of the flow data and at least one historical weighting of the flow data. Additionally, the method comprises determining to provide location information for the at least one location-based resource to the user, wherein the location information comprises one or more of the mapping of the at least one location-based resource on the navigation map and navigation instructions for the at least one location-based resource. The method further comprises the facilitation of a modification of at least one device user interface, wherein the modification of the at least one device user interface is based at least in part on the resource availability data.

In a further embodiment of the foregoing method, the flow data comprises traffic flow of vehicles ending travel at a map location of the at least one location-based resource, and traffic flow of vehicles beginning travel at the map location of the at least one location-based resource, and the flow data is received from one or more of mobile user devices, mobile navigation devices and vehicle navigation devices. The flow data is divided into segments based at least in part on one or more of predetermined intervals of time of day, days of a week, and dates of a year, and the determination of the availability of space at the at least one location-based resource is segmented based at least in part on the segments of the flow data. Additionally, the at least one location-based resource comprises a vehicle parking facility, and the resource availability data comprises availability of parking spaces at the vehicle parking facility.

According to another embodiment, a method comprises facilitating access to at least one interface configured to allow access to at least one service, the at least one service configured, at least in part, to determine to receive flow data of users entering and exiting the at least one location-based resource, to determine availability of space at the at least one location-based resource based at least in part on the flow data, and to determine to provide resource availability data based at least in part on the availability of space at the at least one location-based resource to a user. The at least one interface is further configured, at least in part, to map the at least one location-based resource on a navigation map. The at least one interface is also configured, at least in part, to generate a heat map based at least in part on the flow data of users entering and exiting the at least one location-based resource, wherein the heat map comprises a weighting of the flow data, to determine to receive updated flow data of users entering and exiting the at least one location-based resource at predetermined intervals of time, and to update the heat map based at least in part on the updated flow data, wherein the determination of the availability of space at the at least one location-based resource is further based at least in part on a current weighting of the flow data and at least one historical weighting of the flow data. Additionally, the at least one interface is further configured, at least in part, to determine to provide location information for the at least one location-based resource to the user, wherein the location information comprises one or more of the mapping of the at least one location-based resource on the navigation map and navigation instructions for the at least one location-based resource.

In a further embodiment of the foregoing method, the flow data comprises traffic flow of vehicles ending travel at a map location of the at least one location-based resource, and traffic flow of vehicles beginning travel at the map location of the at least one location-based resource, and the flow data is received from one or more of mobile user devices, mobile navigation devices and vehicle navigation devices. The flow data is divided into segments based at least in part on one or more of predetermined intervals of time of day, days of a week, and dates of a year, and the determination of the availability of space at the at least one location-based resource is segmented based at least in part on the segments of the flow data. Additionally, the at least one location-based resource comprises a vehicle parking facility, and the resource availability data comprises availability of parking spaces at the vehicle parking facility.

According to another embodiment, an apparatus comprises at least one processor, and at least one memory including computer program code, the at least one memory and the computer program code configured to, with the at least one processor, cause the apparatus, at least in part, to determine to receive flow data of users entering and exiting the at least one location-based resource, to determine availability of space at the at least one location-based resource based at least in part on the flow data, and to determine to provide resource availability data based at least in part on the availability of space at the at least one location-based resource to a user. The apparatus is further caused, at least in part, to map the at least one location-based resource on a navigation map. The apparatus is also caused, at least in part, to generate a heat map based at least in part on the flow data of users entering and exiting the at least one location-based resource, wherein the heat map comprises a weighting of the flow data, to determine to receive updated flow data of users entering and exiting the at least one location-based resource at predetermined intervals of time, and to update the heat map based at least in part on the updated flow data, wherein the determination of the availability of space at the at least one location-based resource is further based at least in part on a current weighting of the flow data and at least one historical weighting of the flow data. Additionally, the apparatus is further caused, at least in part, to determine to provide location information for the at least one location-based resource to the user, wherein the location information comprises one or more of the mapping of the at least one location-based resource on the navigation map and navigation instructions for the at least one location-based resource.

In a further embodiment of the foregoing apparatus, the flow data comprises traffic flow of vehicles ending travel at a map location of the at least one location-based resource, and traffic flow of vehicles beginning travel at the map location of the at least one location-based resource, and the flow data is received from one or more of mobile user devices, mobile navigation devices and vehicle navigation devices. The flow data is divided into segments based at least in part on one or more of predetermined intervals of time of day, days of a week, and dates of a year, and the determination of the availability of space at the at least one location-based resource is segmented based at least in part on the segments of the flow data. Additionally, the at least one location-based resource comprises a vehicle parking facility, and the resource availability data comprises availability of parking spaces at the vehicle parking facility.

According to another embodiment, a computer-readable storage medium carrying one or more sequences of one or more instructions which, when executed by one or more processors, cause an apparatus, at least in part, to determine to receive flow data of users entering and exiting the at least one location-based resource, to determine availability of space at the at least one location-based resource based at least in part on the flow data, and to determine to provide resource availability data based at least in part on the availability of space at the at least one location-based resource to a user. The apparatus is further caused, at least in part, to map the at least one location-based resource on a navigation map. The apparatus is also caused, at least in part, to generate a heat map based at least in part on the flow data of users entering and exiting the at least one location-based resource, wherein the heat map comprises a weighting of the flow data, to determine to receive updated flow data of users entering and exiting the at least one location-based resource at predetermined intervals of time, and to update the heat map based at least in part on the updated flow data, wherein the determination of the availability of space at the at least one location-based resource is further based at least in part on a current weighting of the flow data and at least one historical weighting of the flow data. Additionally, the apparatus is further caused, at least in part, to determine to provide location information for the at least one location-based resource to the user, wherein the location information comprises one or more of the mapping of the at least one location-based resource on the navigation map and navigation instructions for the at least one location-based resource.

In a further embodiment of the foregoing computer-readable storage medium, the flow data comprises traffic flow of vehicles ending travel at a map location of the at least one location-based resource, and traffic flow of vehicles beginning travel at the map location of the at least one location-based resource, and the flow data is received from one or more of mobile user devices, mobile navigation devices and vehicle navigation devices. The flow data is divided into segments based at least in part on one or more of predetermined intervals of time of day, days of a week, and dates of a year, and the determination of the availability of space at the at least one location-based resource is segmented based at least in part on the segments of the flow data. Additionally, the at least one location-based resource comprises a vehicle parking facility, and the resource availability data comprises availability of parking spaces at the vehicle parking facility.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining and providing location-based facility resource availability information, such as parking space availability at a parking facility, according to one embodiment;

FIG. 2 is a diagram of the components of user equipment capable of determining and providing location-based facility resource availability information, such as parking space availability at a parking facility, according to one embodiment;

FIG. 3 is a flowchart of a process for determining location-based facility resource availability information, such as parking space availability at a parking facility, according to one embodiment;

FIG. 4 is a flowchart of a process for accessing location-based facility resource availability information, such as parking space availability at a parking facility, according to one embodiment;

FIGS. 5A-5B are diagrams of user interface screens, according to one embodiment;

FIG. 6 is a diagram of a user interface screen that portrays the location-based facility resource availability information, such as parking space availability at a parking facility, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing location-based facility resource availability information, such as parking space availability at a parking facility, independent of any supporting infrastructure installed at the resource facilities, are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

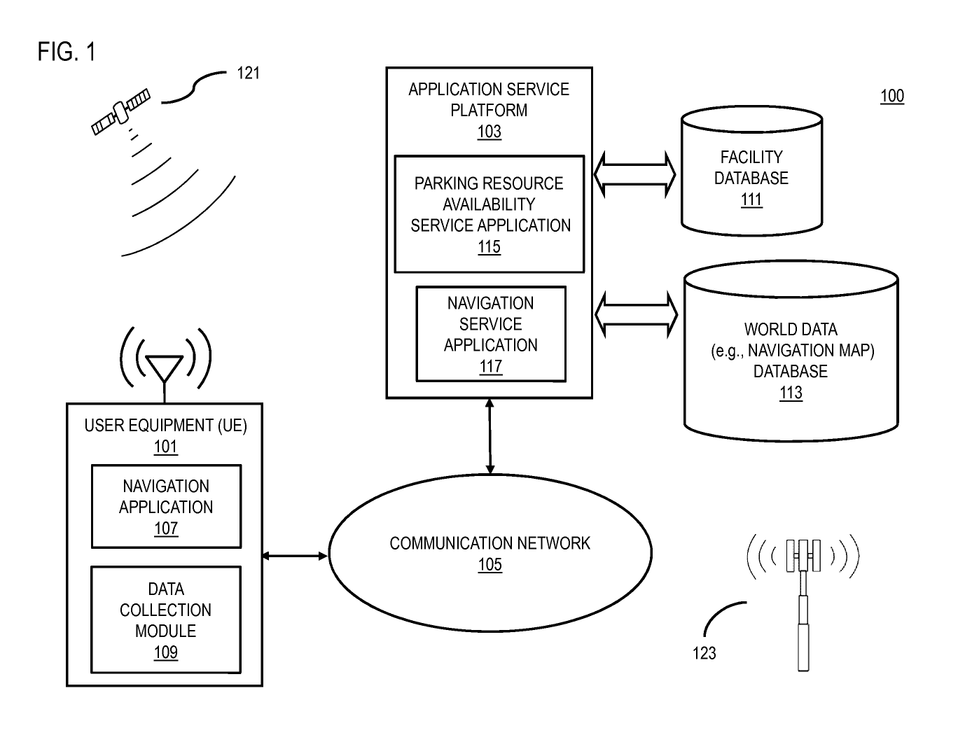

FIG. 1 is a diagram of a system capable of for providing location-based facility resource availability information, such as parking space availability at a parking facility, independent of any supporting infrastructure installed at the resource facilities, according to one embodiment. Navigation systems use location sensing (such as GPS) and electronic mapping technologies to provide navigation services, including the provision of traffic condition information, distance information and estimated travel times. Some navigation systems also provide various navigation-related functions such as location and directions to various types of desired resources, such as restaurants, gas stations, lodging and parking facilities. Additionally, services can be provided, layered over such navigation systems, which provide certain details regarding desired resources. For example, with respect to parking facilities, some such services provide information regarding available parking in parking facilities within the vicinity of the user's location or destination. Current parking availability services, however, require the deployment of supporting infrastructure at the particular parking facilities, such as detector devices for monitoring the specific parking resources and networking and communications infrastructure to access data from such detector devices. The infrastructure adds considerable expense in deploying such parking resource availability services, and limits the services to only those facilities that have been outfitted with the requisite infrastructure.

To address this problem, a system 100 of FIG. 1 introduces the capability to provide a location-based facility resource availability information service, such as parking space availability at a parking facility, independent of any supporting infrastructure installed at the resource facilities. With this approach, location-based facility resource availability information is determined based on traffic flow data received from mobile user navigation devices. Traffic flow data for of vehicles ending and beginning travel at a map location of a particular location-based resource facility, such as a parking garage, is collected from mobile user devices, mobile navigation devices and vehicle navigation devices. A heat map is generated based on the traffic flow data, and the heat map is updated at predetermined time intervals. Resource availability information, such as parking space availability at a parking facility, is determined for the particular facility based on a weighting from the heat map and historical data regarding the facility. For example, the current traffic flows for a parking facility would be compared to normal flows and peak flows for the facility, based on historical data, to determine current parking resource availability status. Moreover, normal and peak flows for a parking facility may further be segmented based on particular time intervals and/or days of the week, and also taking into account the date. The resource availability information is then provided to a user desiring to park at the facility. Accordingly, an embodiment of the present invention provides parking space availability information for a parking facility, independent of any supporting infrastructure installed at the facility.

As shown in FIG. 1, the system 100 comprises a user equipment (UE) 101 having connectivity to an application service platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

Through the navigation application 107 (or other location application or widget), a data collection module 109 of the UE 101 can collect location information (e.g., Global Positioning System (GPS) information based on one or more GPS satellites 121, Assisted GPS (A-GPS), cellular triangulation location information based on triangulation amongst a plurality of cell towers 123, etc.), orientation information (e.g., magnetometer information, accelerometer information, direction information, etc.), combinations thereof, etc. to determine the UE 101's location, speed, acceleration and/or direction or trajectory, which will collectively be referred to as the “UE 101 location data.” The navigation application 107 further maps the UE 101 location data on a navigation map. In certain embodiments, navigation map data can be stored on the UE 101. Navigation map data may include maps, satellite images, street and path information, item information such as POI information, signing information associated with maps, objects and structures associated with the maps, information about people and the locations of people, coordinate information associated with the information, etc., or a combination thereof. An item may be an object (e.g., a representation of a physical object) or a virtual object (e.g., images, audio, video, icons, advertisements, etc.) that can be associated with a location.

The parking resource availability service application 115 of the application service platform 103 connects to the UE 101 through the communication network 105. In one embodiment, the parking resource availability service application 115 is deployed and operated on an application service platform 103 of a wireless network service provider. The parking resource availability service application 115 monitors the UE 101 location data from the UE 101 subscribers of the network service provider. In alternative embodiments, the parking resource availability service application 115 may be deployed and operated on an application service platform 103 of an independent service provider, and the independent service provider may obtain the UE 101 location data for UE 101 subscribers of one or more wireless network service providers. In a further embodiment, the parking resource availability service application 115 may be deployed and operated on a UE 101. For each parking facility for which an application service provider desires to determine parking resource availability information, the parking resource availability service application 115 collects the UE 101 location data from the UE's 101 within a certain vicinity of the parking facility, and determines traffic flow into and out of the parking facility. In an alternate embodiment, the parking resource availability service application 115 may utilize other sources of traffic flow data from any available traffic sensor data, such as data from traffic monitors installed as part of the traffic monitoring infrastructure of various jurisdictions, and traffic flow data obtained from satellite imagery.

In one embodiment, the parking resource availability service application 115 generates a heat map based on the traffic flow of UE's 101 whose location data ends at the parking facility and UE's 101 whose location data begins at the parking facility. A heat map is a well known technique for creating a graphical representation of data where the values taken by a variable in a two-dimensional map are represented as colors. There are many different types of heat maps used in different disciplines, each referred to by the term “heat map,” even though they use different visualization techniques. Geographic heat maps represent location-based data, highlighting trends, anomalies and distributions across a geographic area. A geographic heat map, according to one embodiment, uses a topographic mapping approach and colorizes areas of activity, being the traffic flows into and out of a parking facility. The heat map identifies geographic trends and anomalies in data the traffic flow data, mapping the density of traffic flow entering and remaining at a parking facility at given points or over given intervals of time. The parking resource availability service application 115 further updates the traffic flow data or heat map at predetermined time intervals. The parking resource availability service application 115 compiles the traffic flow and/or heat map data over time, and generates parking resource availability information for a given parking facility.

The UE 101 is any type of mobile terminal, portable terminal including a mobile handset, personal communication system (PCS) device, personal navigation device, vehicle navigation device, personal digital assistant (PDA), positioning device, or any combination thereof, including the accessories and peripherals of these devices, or any combination thereof. It is also contemplated that the UE 101 can support any type of interface to the user (such as “wearable” circuitry, etc.). By way of example, the UE 101 and application service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

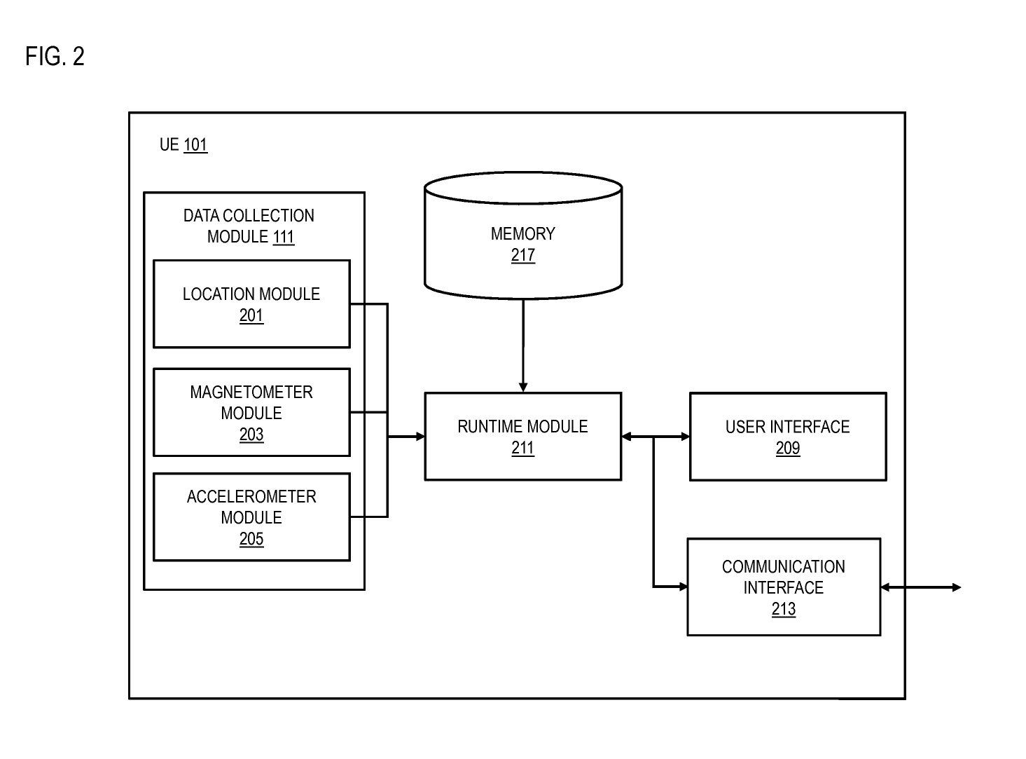

FIG. 2 is a diagram of the components of UE 101, according to one embodiment. By way of example, a UE 101 includes one or more components for providing a GUI utilized in a location-based services application. It is contemplated that the functions of these components may be combined in one or more components or performed by other components of equivalent functionality. In this embodiment, the UE 101 includes a data collection module 109 that may include one or more location modules 201, magnetometer modules 203, accelerometer modules 205, and image capture modules 207. The UE 101 can also include a runtime module 211 to coordinate use of other components of the UE 101, a user interface 209, a communication interface 213, an image processing module 215, and memory 217. An application (e.g., the navigation application 107) of the UE 101 can execute on the runtime module 211 utilizing the components of the UE 101.

The location module 201 can determine location of the UE 101. The location can be determined by a triangulation system such as GPS, A-GPS, Cell of Origin, or other location extrapolation technologies. Standard GPS and A-GPS systems utilize satellites 121 to pinpoint the location of a UE 101. A Cell of Origin system can be used to determine the cellular tower 123 with which a cellular UE 101 is synchronized. This information provides a coarse location of the UE 101 because the cellular tower 123 can have a unique cellular identifier (cell-ID) that can be geographically mapped. Further, a cellular UE 101 may utilize a triangulation method with respect to multiple cell towers 123 to determine the UE 101. The location module 201 may also utilize multiple technologies to detect the location of the location of the UE 101. In one embodiment, the location coordinates can be formatted in a file (e.g., as a vector) and sent to the application services platform 103. Moreover, in certain embodiments, the GPS coordinates can include an altitude to provide a height. The altitude can also be determined using another type of altimeter.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Calculations can be made to determine the direction of the UE 101. The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity.

In one embodiment, the communication interface 213 can be used to communicate with the application services platform 103 or other UEs 101. Certain communications can be via methods such as an internet protocol, messaging (e.g., SMS, MMS, etc.), or any other communication method (e.g., via the communication network 105). In some examples, the UE 101 can send a request to the application services platform 103 via the communication interface 213, and the location services platform 103 may then send a response back via the communication interface 213. Alternatively, the UE 101 can receive a request from the application services platform 103 via the communication interface 213, and the UE 101 may then send a response back via the communication interface 213.

The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. The memory 217 may comprise non-volatile storage. The memory 217 may be used to store various types of information for use in operation of the UE 101, such as software code for the navigation application 107.

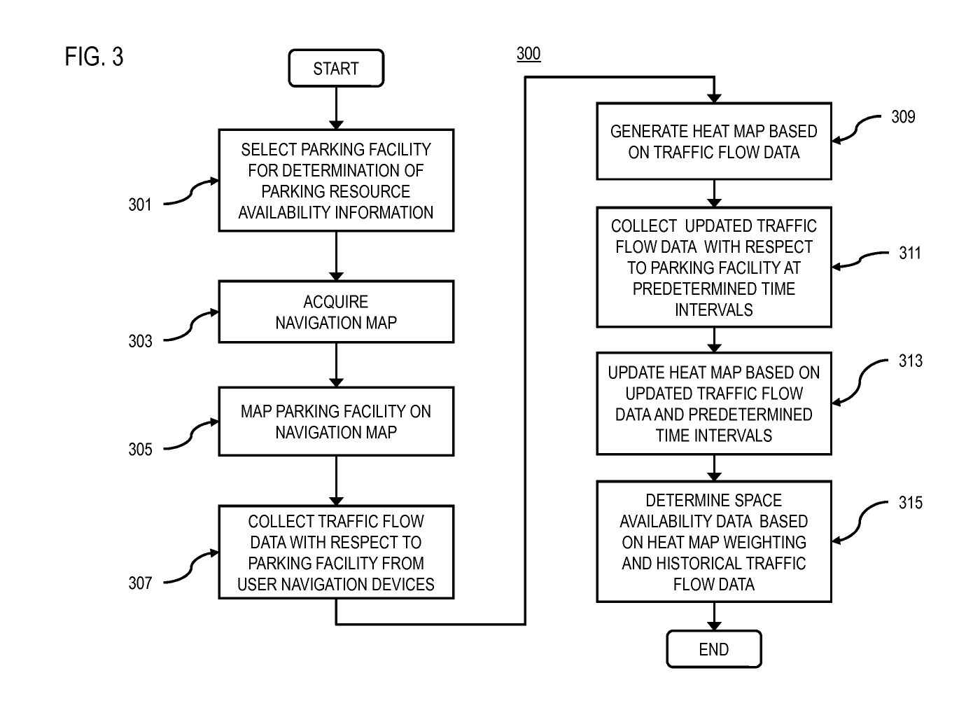

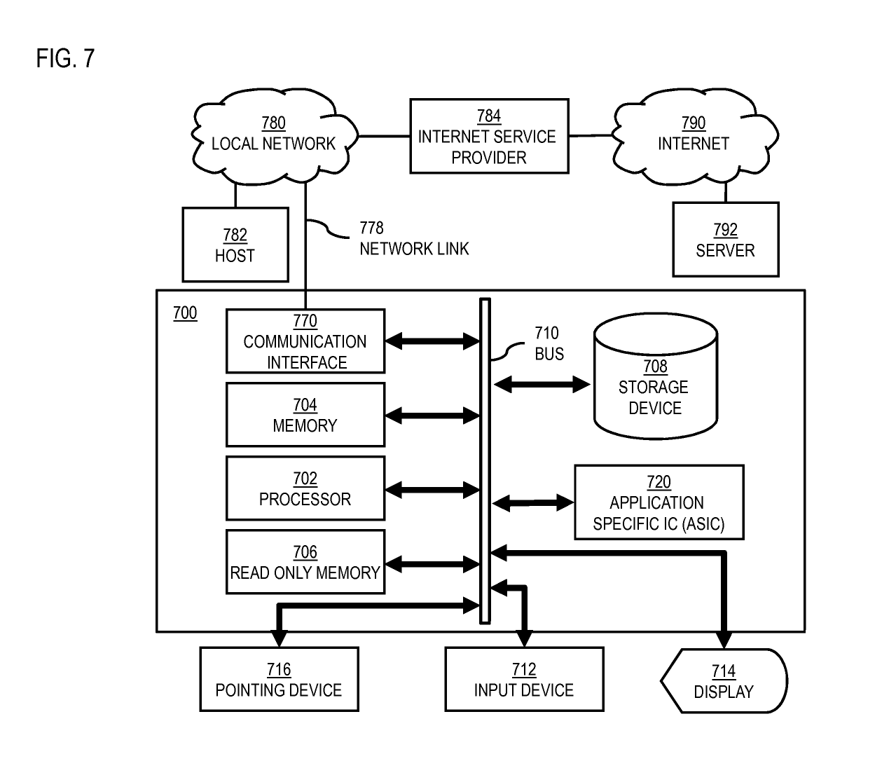

FIG. 3 is a flowchart of a process for determining and providing location-based facility resource availability information, such as parking space availability at a parking facility, independent of any supporting infrastructure installed at the resource facilities, according to one embodiment. In one embodiment, the parking resource availability service application 115, together with the navigation application 117, of the application services platform 103 of FIG. 1 performs the process 300 and is implemented, for instance, on a computer system 700 as shown in FIG. 7. In step 301, the parking resource availability service application 115 selects a parking facility for which it will determine associated parking resource availability information. Next, at step 303, the parking resource availability service application 115 acquires a navigation map covering a predetermined vicinity surrounding the parking facility. In an alternate embodiment, the parking resource availability service application 115 may be equipped with associated navigation application software in order to generate the navigation map itself. At step 305, parking resource availability service application 115 maps the parking facility on the navigation map. Next, at step 307, the parking resource availability service application 115 collects traffic flow data with respect to the parking facility.

The traffic flow data will comprise a count of the number of vehicles determined to have parked within the parking facility. The determination of when a vehicle has parked at the facility would be made for a vehicle travelling towards the parking facility and terminating its travel movement at a point on the navigation map that coincides with the street entrance(s) into the parking facility. The termination of a vehicle's travel movement at the parking facility may be determined based on the termination of the vehicles movement at the location of the parking facility for a predetermined period of time (e.g., 15 minutes or longer). Also, the predetermined period of time may vary for different parking facilities depending on their location, and may be adjusted during the learning process of the parking resource availability service application 115 for a particular parking facility (described in further detail below). For example, the predetermined period of time for a parking facility at a train station may be longer (e.g., 30 or 60 minutes or longer), based on the type of traffic that utilizes the facility. At a train station, vehicles may access the facility for an extended time period (e.g., 20 minutes) waiting to pick up a passenger from a train that has not yet arrived, and thus may terminate travel at the station for such time period, but are not utilizing a parking space at the facility.

The traffic flow data will further comprise a count of the number of vehicles determined to have vacated a parking space and exited the parking facility. The determination of when a vehicle has vacated a parking space and exited the parking facility would be made for a vehicle that, after being stopped at the facility for a predetermined period of time (e.g., 15 minutes or longer) begins its travel movement at a point on the navigation map that coincides with the street exit(s) out of the parking facility, and travels away from the parking facility. Here also, the predetermined period of time may vary for different parking facilities depending on their location, and may be adjusted during the learning process of the parking resource availability service application 115 for a particular parking facility (described in further detail below).

The determination as to when a vehicle has parked at the facility could further be based on telemetry (e.g., speed and direction) of a subscriber mobile UE 101. For example, in one embodiment, the parking resource availability service application 115 can monitor the telemetry of a subscriber UE 101, and determine that the UE 101's telemetry indicates that the subscriber has left the vehicle and is currently on foot walking. Additionally, the parking resource availability service application 115 can monitor the telemetry of the subscriber UE 101, and determine, based on the metrics of movement, that the subscriber's movement is within a destination facility (e.g., based on the movement being within a limited area, such as within a building or shopping center, as opposed to movement of a pattern indicative of movement on roadways). In a further embodiment, the parking resource availability service application 115 can determine that the subscriber has parked in the parking facility based on the disabling of the navigation application 107 on the UE 101 upon arrival at a point on the navigation map that coincides with the parking facility. Additionally, in one embodiment, the parking resource availability service application 115 could be capable of determining that, upon arrival at the parking facility, the subscriber has arrived at a destination point of the navigation application 107 of the UE 101, and one or more of the above circumstances of telemetry indicate that the subscriber has parked and exited the vehicle at the parking facility.

Similarly, the determination as to when a vehicle has vacated a parking space and exited the parking facility could also further be based on telemetry (e.g., speed and direction) of a subscriber mobile UE 101. For example, in one embodiment, the parking resource availability service application 115 can monitor the telemetry of a subscriber UE 101, and determine that the UE 101's telemetry indicates that the subscriber has entered the vehicle, and the UE 101's movement becomes indicative of driving versus walking. Additionally, the parking resource availability service application 115 can monitor the telemetry of the subscriber UE 101, and determine, based on the metrics of movement, that the subscriber's movement is no longer within the destination facility (e.g., based on the movement being of a pattern indicative of movement on roadways, as opposed to movement within a limited area, such as within a building or shopping center). In a further embodiment, the parking resource availability service application 115 can determine that the subscriber has resumed travel in a vehicle based on the enabling of the navigation application 107 of the UE 101. Additionally, in one embodiment, the parking resource availability service application 115 could be capable of determining that the subscriber has initiated a new destination point through the navigation application 107 of the UE 101, and one or more of the above circumstances of telemetry indicate that the subscriber has begun travelling away from the parking facility.

As specified above, in one embodiment, the parking resource availability service application 115 is operated by a wireless network service provider, and monitors the UE 101 location data from the provider's UE 101 wireless subscribers. The parking resource availability service application 115 may further collect traffic flow data from subscriber vehicle navigation devices, and navigation applications of the subscriber UE 101 mobile devices. The parking resource availability service application 115 collects the UE 101 location data from the UE's 101 within a certain vicinity of the parking facility. From that data, based on a statistical analysis with respect to the ratio of subscribers to general population, the parking availability application determines traffic flow into and out of the parking facility. In an alternate embodiment, the parking resource availability service application 115 may utilize other sources of traffic flow data from any available traffic sensor data, such as data from traffic monitors installed as part of the traffic monitoring infrastructure of various jurisdictions, and traffic flow data obtained from satellite imagery.

At step 309, the parking resource availability service application 115 generates a heat map based on the traffic flow data collected for the parking facility. Further, at step 311, the parking resource availability service application 115 collects updated traffic flow data at predetermined time intervals. Next, at step 313, the parking resource availability service application 115 updates the heat map based on the updated traffic flow data and the predetermined time intervals.

At step 315, the parking resource availability service application 115 compiles the traffic flow and/or heat map data over time, and generates parking resource availability information for a given parking facility, stores the generated parking resource availability information in the facility database 111, in association with the respective parking facility. In one embodiment, based on the time intervals of the traffic flow data and the heat map data over time, the parking resource availability service application 115 generates the parking resource availability information for particular intervals of time and segments the information based on such time intervals. Further, the particular time intervals may differ based on the day of the week and/or the date. For example the parking resource availability service application 115 may segment the parking resource availability information for a parking facility in a metropolitan area based on weekdays, and work hours, peak evening hours and late evening/early morning hours of a weekday, and weekend days, and peak daytime, peak evening and late evening/early morning hours of a weekend day.

In one embodiment, the parking resource availability service application 115 employs a learning process over time, continually updating and compiling traffic flow and/or heat map data, and updating a database of parking resource availability information for a given parking facility. Further, the current traffic flows for a parking facility would be compared to continually updated normal flows and peak flows for the facility, based on historical data, to determine current resource availability status. The learning process may further involve obtaining feedback, based on user experience with respect to use of the service for particular parking facilities, from subscribers to the parking resource availability service. Accordingly, the accuracy of the parking resource availability information improves over the learning process for a given parking facility.

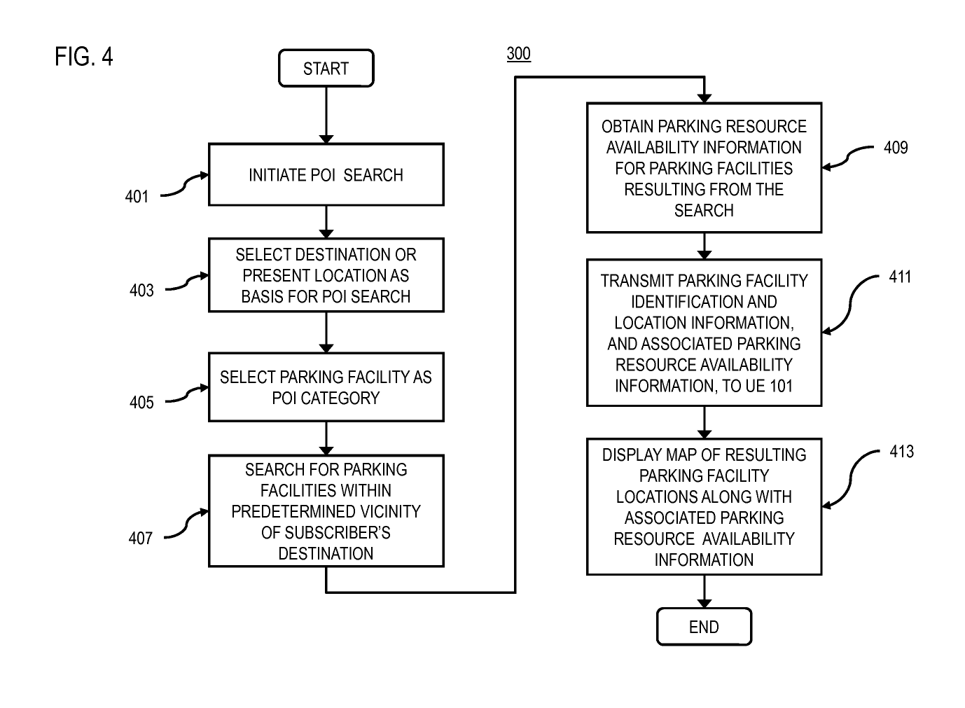

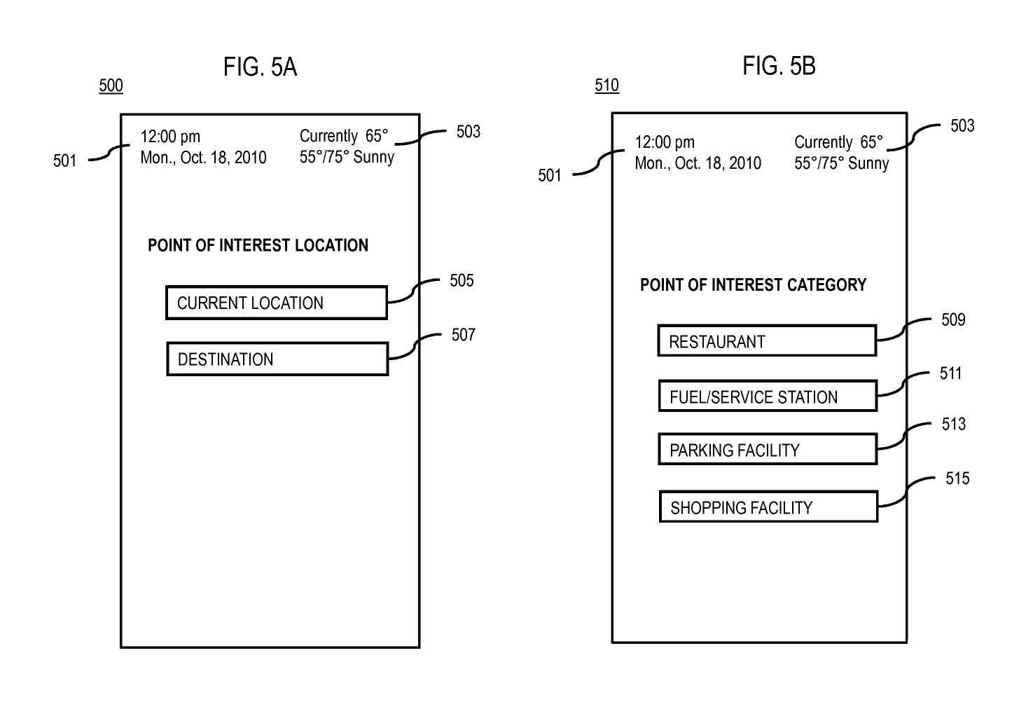

FIG. 4 depicts a flow chart illustrating a process whereby a subscriber obtains location-based resource availability information, such as parking space availability at a parking facility, independent of any supporting infrastructure installed at the resource facilities, according to one embodiment. In this embodiment, for example, the parking resource availability service application 115 is offered through the navigation application 107 of the UE 101. In alternate embodiments, the parking resource availability service application may be offered to the subscriber through an independent application of the UE 101, or through a remote server (e.g., the application service platform 103) of the service provider, on a server/client basis. Pursuant to the process of FIG. 4, in one embodiment, the navigation application 107 displays a series of screens on the user interface 209 of the UE 101, as illustrated in FIGS. 5A-5C. First, at step 401, the subscriber selects a point of interest (POI) search. At that point, the navigation application 107 displays the screen 500 (depicted in FIG. 5A) on the user interface 209, which provides the subscriber with an option to search for particular points of interest within the vicinity of the subscribers current location 505 or within the vicinity of the subscribers destination 507. At step 403, for example, the subscriber selects the “present location” option 505. In one embodiment, the user interface screen 500 may display further information such as the current time, day and date 501 and the current weather and weather forecast for the day 503.

Upon selection of the “present location” option 505, the navigation application 107 displays the screen 510 (depicted in FIG. 5B) on the user interface 209. Pursuant to the screen 510, the subscriber is offered a selection of various POI categories to search—for example, a “restaurant” selection 509, a “fuel/service station” selection 511, a “parking facility” selection 513, and a “shopping facility” 515. At step 405, the subscriber selects the “parking facility” selection 513. The selection of the parking facility option initiates a search by the parking resource availability service application 115 on the application service platform 103. Accordingly, at step 407, the parking resource availability service application 115 searches for parking facilities within a predetermined vicinity (e.g., 1 mile) of the subscriber's current location. According to one embodiment, the predetermined vicinity may be predefined in a set of predefined preferences set up by the subscriber with respect to the navigation application and/or the parking resource availability application of the UE 101. Alternatively, as an intermediate step (not shown), the navigation application 107 may present the subscriber with an option to select a radial distance surrounding the subscriber's current location within which the subscriber desires the search to be conducted. At step 409, the parking resource availability service application 115 obtains the parking resource availability information from the facility database 111 for each of the parking facilities identified pursuant to the search conducted in step 407. Then, at step 411, the parking resource availability service application 115 transmits identification and location information for the parking facilities that resulted from the search, along with the associated parking resource availability information for each such parking facility, to the UE 101.

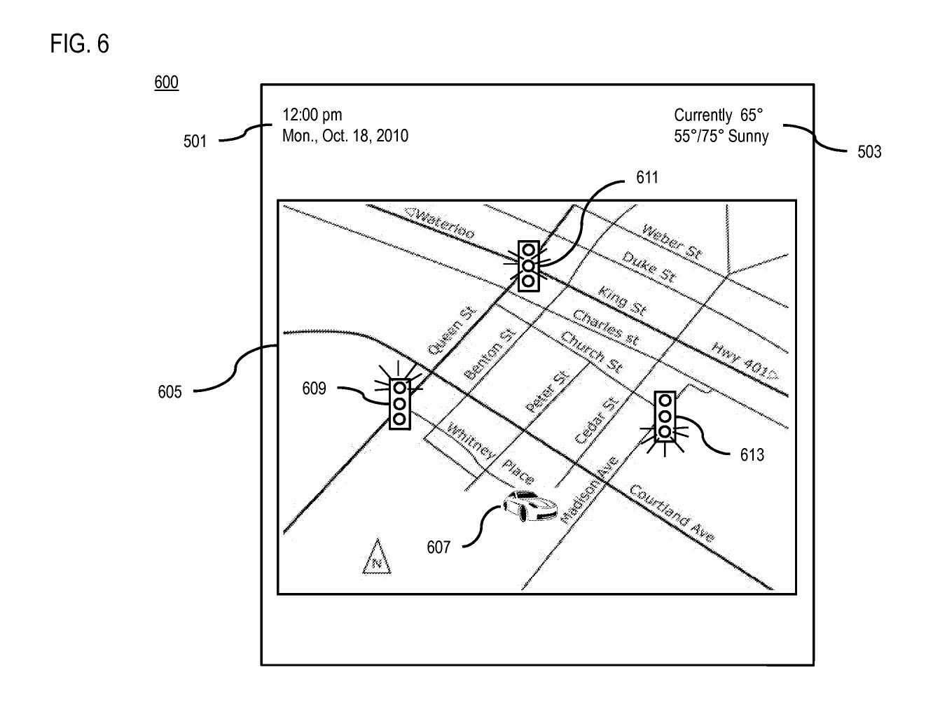

Upon receipt of the transmitted information from the parking resource availability service application 115, at step 413, the navigation application 107 displays the screen 520 (depicted in FIG. 6) on the user interface 209, which provides a pictorial street map 605 of the predetermined vicinity of the subscriber's current location. The map 605 includes an icon 607, depicting the subscriber's current location on the map. For the parking facilities and the associated parking resource availability information, in one embodiment, the map 605 displays the icons 609, 611 and 613 depicting the location of the parking facilities on the map 605. In this embodiment, the icons are in the form of traffic signals, with one of the signals on the traffic signal illuminated to portray the associated parking resource availability information. For example, on the icon 609, the red signal is illuminated to indicate that there is no parking availability at the respective facility. On the icon 611, the yellow signal is illuminated to indicate that there is limited parking availability at the respective facility, and thus the subscriber should proceed with caution for this facility. On the icon 613, the green signal is illuminated to indicate that there ample parking availability at the respective facility. In a further embodiment, the parking facility icon may simply be a red, yellow or green indicator (e.g., illuminated circle). In alternate embodiments, the parking facility identification and location, and the associated parking resource availability information, may be depicted in a list fashion (not shown), or may be conveyed via an audible notification, or in any other appropriate fashion. Further, with respect to a location-based resource covering a geographical area, the area of interest may be shaded in red, yellow or green, with the above-attributed meanings, respectively. Additionally, in a further embodiment, the subscriber may select a particular parking facility (e.g., in the case of a touch screen user interface 209, the subscriber need only touch the screen at the point where the desired facility is located). The navigation application 107 would then change the subscriber's destination to the selected parking facility, and provide navigation instructions for reaching the selected facility. In further embodiments, the navigation instructions may be conveyed via a pictorial map route, a textual list of navigation instructions, audible (e.g., voice) navigation instructions, or in any other appropriate fashion.

In another embodiment, in the event that the subscriber selects the “destination” option 507 at step 403, the parking resource availability service application determines the parking facilities within a predetermined vicinity of the subscriber's destination and the associated parking resource availability information for those facilities. The parking resource availability service application 115 then transmits identification and location information for the parking facilities that resulted from the determination, along with the associated parking resource availability information for each such parking facility, to the UE 101. The subscriber may then select a desired parking facility. In one embodiment, upon the selection of a desired parking facility, through the navigation application 107, the UE 101 would display one or more potential navigation routes from the subscriber's present location to the selected parking facility. In an a further embodiment, the parking resource availability service application 115 transmits identification and navigation route information for the parking facilities that resulted from the determination, along with the associated parking resource availability information for each such parking facility, to the UE 101, and the subscriber need only select a desired route. In further embodiments, the navigation instructions may be conveyed via a pictorial map route, a textual list of navigation instructions, audible (e.g., voice) navigation instructions, or in any other appropriate fashion.

While the apparatus, systems and methods for determining and providing location-based facility resource availability information, independent of any supporting infrastructure installed at the resource facilities, have been described herein with respect to parking resource availability at a parking facility, the methodology would be applicable to any location-based resource. For example, in a further embodiment, the traffic flow analysis process, as applied above to parking facilities, could similarly be applied to a predetermined geographical region of street parking resources. Each predetermined geographic region would be treated as a “parking facility” in accordance with the embodiments described above. Accordingly, traffic flows ending and beginning within the predetermined geographical area could be collected from the UE 101 location data (being the location information, orientation information, etc. for determining the UE 101's location, speed, acceleration and/or direction or trajectory, as defined above), and analyzed as described herein to ascertain and provide street parking availability information for the predetermined geographical region.

In a further embodiment, the methodologies of the foregoing embodiments may be applied, to determining and providing information regarding identification of and resource availability at a public event. For example, a location-based event identification and resource availability service may be provided to a subscriber, whereby the subscriber is informed of events currently occurring within a predetermined vicinity of the subscriber or the subscriber's destination or a predetermined geographical area. Through traffic flow and heat map analyses, as described above, identification of high density or hot points within the predetermined vicinity or geographical area can be noted, and together with public event information (e.g., ascertained through an Internet search), identification of public events at such points within the vicinity or geographical area can be provided to the subscriber.

The processes described herein for determining and providing location-based facility resource availability information, such as parking space availability at a parking facility, independent of any supporting infrastructure installed at the resource facilities, may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to determine and provide location-based facility resource availability information, such as parking space availability at a parking facility, as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of a process for determining and providing location-based facility resource availability information, such as parking space availability at a parking facility, independent of any supporting infrastructure installed at the resource facilities.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to a process for determining and providing location-based facility resource availability information, such as parking space availability at a parking facility, independent of any supporting infrastructure installed at the resource facilities. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for determining and providing location-based facility resource availability information, such as parking space availability at a parking facility, independent of any supporting infrastructure installed at the resource facilities. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for determining and providing location-based facility resource availability information, such as parking space availability at a parking facility, independent of any supporting infrastructure installed at the resource facilities, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing location-based facility resource availability information, such as parking space availability at a parking facility to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

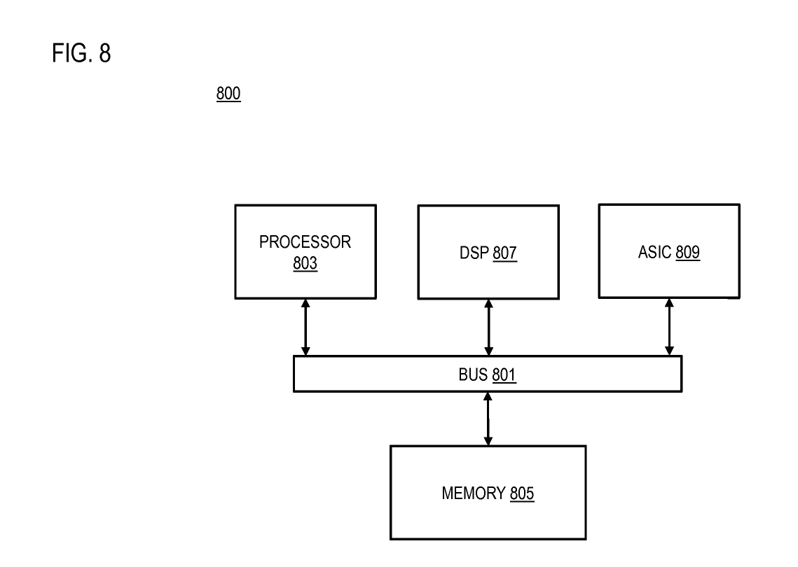

FIG. 8 illustrates a chip set or chip 800 upon which an embodiment of the invention may be implemented. Chip set 800 is programmed for determining and providing location-based facility resource availability information, such as parking space availability at a parking facility, as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of a process for determining and providing location-based facility resource availability information, such as parking space availability at a parking facility, independent of any supporting infrastructure installed at the resource facilities.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein for determining and providing location-based facility resource availability information, such as parking space availability at a parking facility, independent of any supporting infrastructure installed at the resource facilities The memory 805 also stores the data associated with or generated by the execution of the inventive steps.

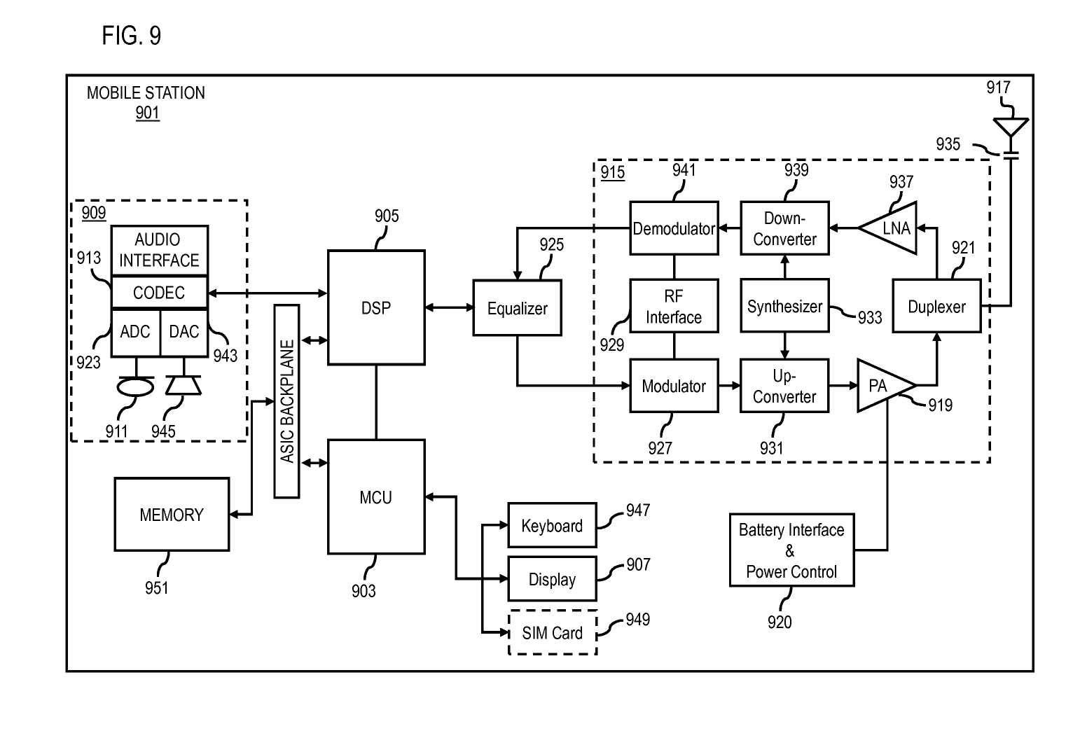

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of a process for determining and providing location-based facility resource availability information, such as parking space availability at a parking facility, independent of any supporting infrastructure installed at the resource facilities. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the mobile terminal include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of determining and providing location-based facility resource availability information, such as parking space availability at a parking facility, independent of any supporting infrastructure installed at the resource facilities. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 providing location-based facility resource availability information, such as parking space availability at a parking facility, independent of any supporting infrastructure installed at the resource facilities. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing: (1) data and/or (2) information and/or (3) at least one signal;
the (1) data and/or (2) information and/or (3) at least one signal based at least in part on the following:
flow data of users entering and exiting at least one location-based resource;
a determination of availability of space at the at least one location-based resource based at least in part on the flow data; and
a determination to provide resource availability data, based at least in part on the availability of space at the at least one location-based resource, to a user.

2. A method of claim 1, wherein the (1) data and/or (2) information and/or (3) at least one signal are further based at least in part on the following:
a mapping of the at least one location-based resource on a navigation map, wherein the flow data comprises traffic flow of vehicles ending travel at a map location of the at least one location-based resource, and traffic flow of vehicles beginning travel at the map location of the at least one location-based resource.

3. A method of claim 2, wherein the at least one location-based resource comprises a vehicle parking facility, and the resource availability data comprises availability of parking spaces at the vehicle parking facility.

4. A method of claim 2, wherein the (1) data and/or (2) information and/or (3) at least one signal are further based at least in part on the following:
a determination to provide location information for the at least one location-based resource to the user.

5. A method of claim 4, wherein the location information comprises one or more of the mapping of the at least one location-based resource on the navigation map and navigation instructions for the at least one location-based resource.

6. A method of claim 1, wherein the (1) data and/or (2) information and/or (3) at least one signal are further based at least in part on the following:
a heat map based at least in part on the flow data of users entering and exiting the at least one location-based resource, wherein the heat map comprises a weighting of the flow data.

7. A method of claim 6, wherein the (1) data and/or (2) information and/or (3) at least one signal are further based at least in part on the following:
updated flow data of users entering and exiting the at least one location-based resource at predetermined intervals of time; and
an updated heat map based at least in part on the updated flow data, wherein the determination of the availability of space at the at least one location-based resource is further based at least in part on a current weighting of the flow data and at least one historical weighting of the flow data.

8. A method of claim 1, wherein the flow data is received from one or more of mobile user devices, mobile navigation devices and vehicle navigation devices.

9. A method of claim 1, wherein
the flow data is divided into segments based at least in part on one or more of predetermined intervals of time of day, days of a week, and dates of a year, and
the determination of the availability of space at the at least one location-based resource is segmented based at least in part on the segments of the flow data.

10. An apparatus comprising:
at least one processor; and
at least one memory including computer program code for one or more programs,
the at least one memory and the computer program code configured to, with the at least one processor, cause the apparatus to perform at least the following,
determine flow data of users entering and exiting the at least one location-based resource;
determine an availability of space at the at least one location-based resource based at least in part on the flow data; and
determine to provide resource availability data based at least in part on the availability of space at the at least one location-based resource to a user.

11. An apparatus of claim 10, wherein the apparatus is further caused to:
cause, at least in part, mapping of the at least one location-based resource on a navigation map, wherein the flow data comprises traffic flow of vehicles ending travel at a map location of the at least one location-based resource, and traffic flow of vehicles beginning travel at the map location of the at least one location-based resource.

12. An apparatus of claim 11, wherein the at least one location-based resource comprises a vehicle parking facility, and the resource availability data comprises availability of parking spaces at the vehicle parking facility.

13. An apparatus of claim 11, wherein the apparatus is further caused to:
determine to provide location information for the at least one location-based resource to the user.

14. An apparatus of claim 13, wherein the location information comprises one or more of the mapping of the at least one location-based resource on the navigation map and navigation instructions for the at least one location-based resource.

15. An apparatus of claim 10, wherein the apparatus is further caused to:
determine to generate a heat map based at least in part on the flow data of users entering and exiting the at least one location-based resource, wherein the heat map comprises a weighting of the flow data.

16. An apparatus of claim 15, wherein the apparatus is further caused to:
determine updated flow data of users entering and exiting the at least one location-based resource at predetermined intervals of time; and
cause, at least in part, updating of the heat map based at least in part on the updated flow data, wherein the determining of the availability of space at the at least one location-based resource is further based at least in part on a current weighting of the flow data and at least one historical weighting of the flow data.

17. An apparatus of claim 10, wherein the flow data is received from one or more of mobile user devices, mobile navigation devices and vehicle navigation devices.

18. An apparatus of claim 10, wherein
the flow data is divided into segments based at least in part on one or more of predetermined intervals of time of day, days of a week, and dates of a year, and
the determining of the availability of space at the at least one location-based resource is segmented based at least in part on the segments of flow data.

19. A computer-readable storage medium carrying one or more sequences of one or more instructions which, when executed by one or more processors, cause an apparatus to at least perform the following steps:
determining flow data of users entering and exiting the at least one location-based resource;
determining an availability of space at the at least one location-based resource based at least in part on the flow data; and
determining to provide resource availability data based at least in part on the availability of space at the at least one location-based resource to a user.

20. A computer-readable storage medium of claim 19, wherein the apparatus is caused to further perform:
causing, at least in part, mapping of the at least one location-based resource on a navigation map, wherein the flow data comprises traffic flow of vehicles ending travel at a map location of the at least one location-based resource, and traffic flow of vehicles beginning travel at the map location of the at least one location-based resource.

21.-66. (canceled)
